(19) United States
(12) Patent Application Publication
(10) Pub. No.: US 2013/0171445 A1
(43) Pub. Date: Jul. 4, 2013

(54) COATED ARTICLE AND METHOD FOR MANUFACTURING THE SAME

(71) Applicants: REN-BO WANG, Shenzhen City (CN); YONG-GANG ZHU, Shenzhen City (CN); XIN-WU GUAN, Shenzhen City (CN)

(72) Inventors: REN-BO WANG, Shenzhen City (CN); YONG-GANG ZHU, Shenzhen City (CN); XIN-WU GUAN, Shenzhen City (CN)

(21) Appl. No.: 13/656,799

(22) Filed: Oct. 22, 2012

(30) Foreign Application Priority Data
Dec. 28, 2011 (CN) 201110447339.2

(51) Int. Cl. B32B 15/08; C23C 4/10; B32B 33/00

(52) U.S. Cl. 428/334; 428/450; 427/453

(57) ABSTRACT

A coated article includes a metal substrate, and an enamel composite layer formed on the metal substrate. The enamel composite layer mainly includes silicon oxide, aluminium oxide, sodium oxide, potassium oxide, and fiber reinforced materials. A method for making the coated articles is also provided.

### BACKGROUND

1. Technical Field

The exemplary disclosure generally relates to a coated article and a method for manufacturing the coated article.

2. Description of Related Art

Enamel coatings can be formed on metal substrates by electrostatic adsorption. The enamel coatings improve abrasion resistance of metal substrates and are also decorative. However, the enamel coatings formed by electrostatic adsorption commonly have low density, low hardness, and uneven thickness. Furthermore, the enamel coatings weakly bond to the substrate. Additionally, the enamel coatings have low impact resistance and poor toughness, and so are easily damaged.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary disclosure. Moreover, in the drawings, like reference numerals designate corresponding parts throughout the several views. Wherever possible, the same reference numbers are used throughout the drawings to refer to the same or like elements of an embodiment.

FIG. 1 is a cross-sectional view of an exemplary embodiment of an article.

FIG. 2 is a perspective view of an exemplary embodiment of a fastening device.

FIG. 3 is a perspective view of using the fastening device of FIG. 2.

### DETAILED DESCRIPTION

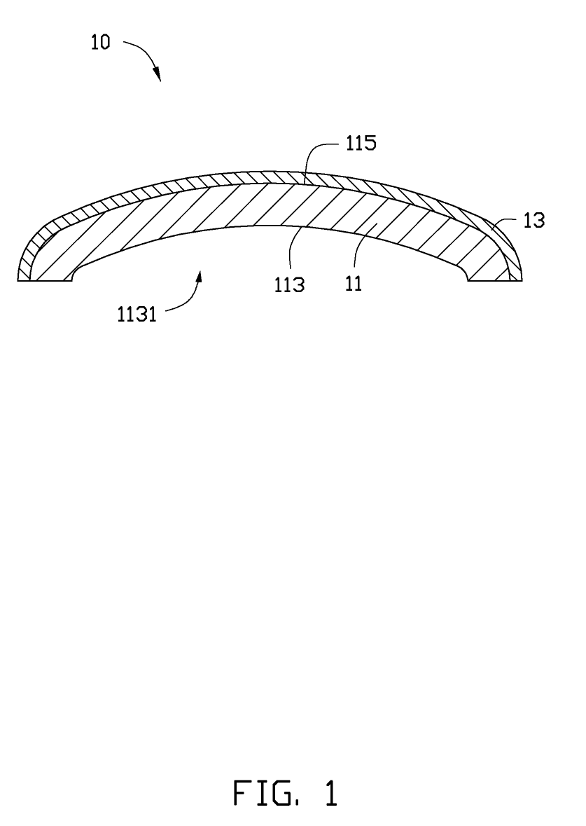

Referring to FIG. 1, a coated article 10 according to an exemplary embodiment includes a metal substrate 11 and an enamel composite layer 13 formed on the metal substrate 11.

The metal substrate 11 may be made of stainless steel or titanium alloy.

The enamel composite layer 13 is formed on the metal substrate 11 by flame spraying. The enamel composite layer 13 mainly consists of silicon oxide, aluminium oxide, sodium oxide, potassium oxide, and fiber reinforced materials, wherein the mass percentage of the silicon oxide is about 60-70%, the mass percentage of the aluminum oxide is about 15-20%, the mass percentage of the sodium oxide is about 4-6%, the mass percentage of the potassium oxide is about 4-6%, and the mass percentage of the fiber reinforced materials is about 8-15%. The fiber reinforced materials may comprise at least one fiber selected from a group consisting of carbon fiber, glass fiber, and boron fiber. The fiber reinforced materials form a reinforcing cross-linking structure in the enamel composite layer 13. The enamel composite coating 13 may further comprise a pigment selected from a group consisting of ferric oxide, calcium oxide, magnesium oxide, and titanium oxide. The mass percentage of the pigment is about 1-9%. The thickness of the enamel composite layer 13 is about 50 μm to about 150 μm.

A method for manufacturing the coated article 10 may include at least the following steps:

The metal substrate 11 is provided. The metal substrate 11 may be made of stainless steel or titanium alloy. The metal substrate 11 includes a first surface 113 and an opposite second surface 115. The first surface 113 defines a receiving space 1131.

The second surface 115 of the metal substrate 11 is roughened by sandblasting, chemical etching, or the like. The roughening process improves the bond between the metal substrate 11 and the enamel layer 13. After being roughened, the surface roughness (Ra) of the second surface 115 is about 0.4 μm to about 1.2 μm.

The enamel composite layer 13 is formed on the second surface 115 by flame spraying. A spraying powder used to form the enamel composite layer 13 mainly consists of silicon oxide, aluminium oxide, sodium oxide, potassium oxide, and fiber reinforced materials, wherein the mass percentage of the silicon oxide is about 60-70%, the mass percentage of the aluminum oxide is about 15-20%, the mass percentage of the sodium oxide is about 4-6%, the mass percentage of the potassium oxide is about 4-6%, and the mass percentage of the fiber reinforced materials is about 8-15%. The fiber reinforced materials may comprise at least one fiber selected from a group consisting of carbon fiber, glass fiber, and boron fibers. The fiber reinforced materials form a reinforcing cross-linking structure in the enamel composite layer 13. The enamel composite coating 13 may further comprise a pigment selected from a group consisting of ferric oxide, calcium oxide, magnesium oxide, and titanium oxide. The mass percentage of the pigment is about 1-9%. The thickness of the enamel composite layer 13 is about 50 μm to about 150 μm.

During the flame spraying process, the temperature of the spraying powder is about 800-1200° C., and the temperature of the metal substrate 11 is kept below 600° C., which can prevent the metal substrate 11 from being distorted by heat. The fiber reinforced materials of the enamel composite layer 13 can prevent micro-cracks formed in the enamel composite layer 13 from diffusing to any other regions of the enamel composite layer 13, thus improving impact resistance and toughness of the layer 13. The enamel composite layer 13 has a porosity of about 4-8%.

The exposed surface of the enamel composite layer 13 is roughened by sandblasting, grinding, or the like. After being roughened, the surface roughness (Ra) of the enamel composite layer 13 is about 1.6 μm to about 6.3 μm.

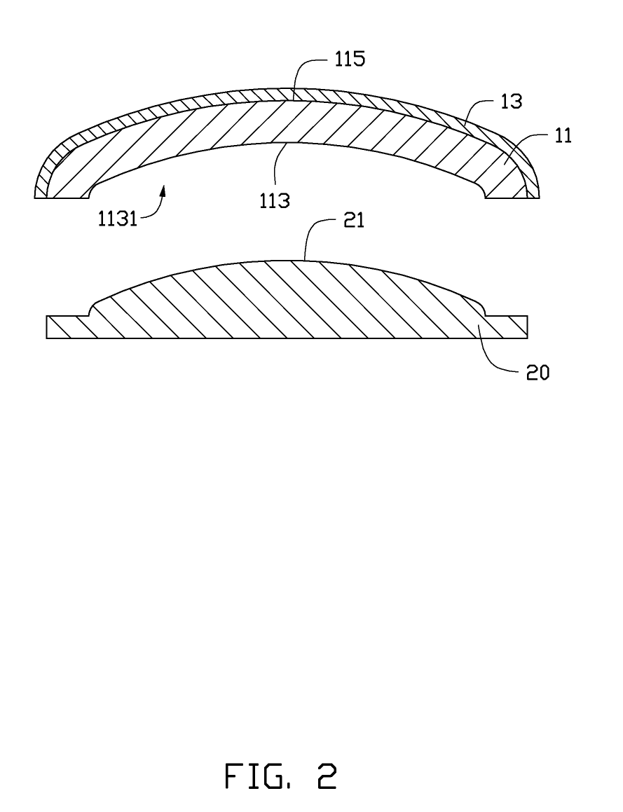

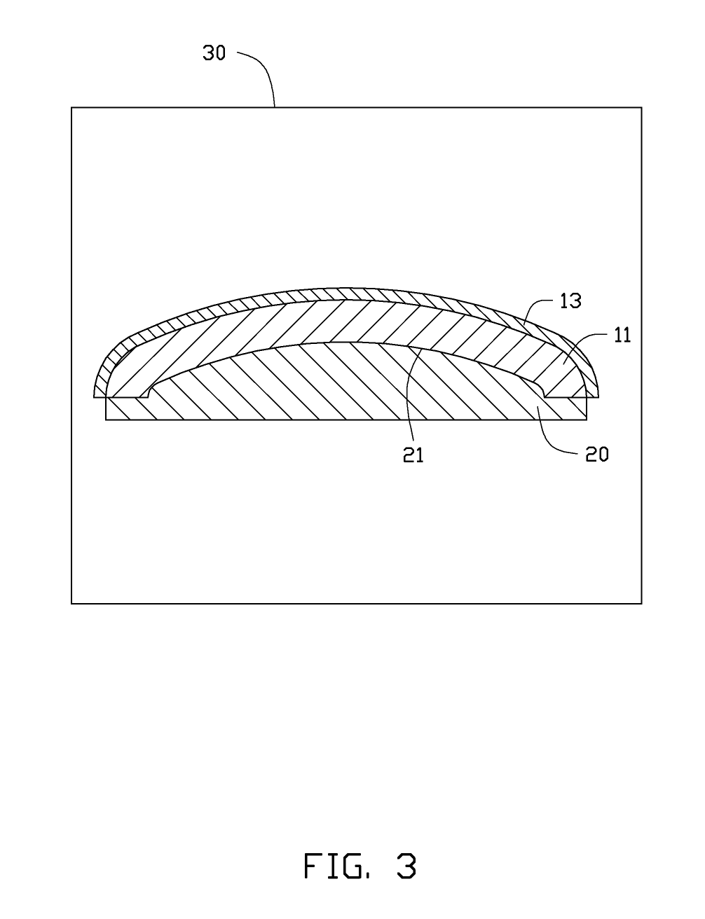

Referring to FIGS. 2 and 3, the enamel composite layer 13 is subjected to hot isostatic pressing (HIP) to enhance the density, hardness, and toughness of the enamel composite layer 13. The HIP process also enhances the bond between the enamel composite layer 13 and the metal substrate 11. The HIP process may include the following steps:

A fastening device 20 is provided. The fastening device 20 defines a positioning portion 21 corresponding to the receiving space 1131 of the metal substrate 11. During the HIP process, the fastening device 20 supports the metal substrate 11 to prevent the metal substrate 11 from being distorted by high temperatures.

The metal substrate 11 is positioned on the fastening device 20, and the positioning portion 21 supports the receiving space 1131 of the metal substrate 11.

An HIP furnace 30 (schematically shown) is provided (referring to FIG. 3). The metal substrate 11 having the enamel composite layer 13 configured with the fastening device 20 are positioned in the HIP furnace 30. Argon gas is fed into the HIP furnace 30 at a flow rate of about 2-4 L/min. The inner temperature of the furnace 30 is about 600-800° C., and the inner pressure of the furnace 30 is about 100-200 MPa. The HIP process for the enamel composite layer 13 may last for about 40-120 minutes.

After the HIP process, the coated article 10 is removed from furnace 30. The exposed surface of the enamel composite layer 13 is ground or polished to eliminate contaminants that may have formed on the enamel composite layer 13 and smoothens the exposed surface of the enamel composite layer 13. After being ground or polished, the surface roughness (Ra) of the enamel composite layer 13 is about 0.03-0.08 μm.

As previously mentioned, the enamel composite layer 13 of the exemplary embodiment is formed by flame spraying followed by a HIP process, which provides the enamel composite layer 13 an enhanced density, an even thickness, and an improved bond between the enamel composite layer 13 and the metal substrate 11. Since the enamel composite layer 13 has an enhanced density, when subject to impacts, internal micro-cracks that may have formed in the enamel composite layer 13 will not easily diffuse to any other regions forming bigger cracks. As such, crack resistance and shock resistance of the coated article 10 is improved.

Furthermore, the cross-linking structure of the fiber reinforced materials in the enamel composite layer 13 further enhances the strength and toughness of the enamel composite layer 13. Even if big cracks were to form, such as during rough handling of the substrate 11, in the enamel composite layer 13, they also would not diffuse because of the cross-linking structure of the fiber reinforced materials in the enamel composite layer 13.

### Example Article 1

A metal substrate 11 was provided. The metal substrate 11 was made of stainless steel.

The metal substrate 11 was roughened by sandblasting. After sandblasting, the surface roughness (Ra) of the second surface 115 was about 0.8 μm.

Forming the enamel composite layer 13: A spraying powder used to form the enamel composite layer 13 mainly consisted of silicon oxide, aluminium oxide, sodium oxide, potassium oxide and glass fiber, wherein the mass percentage of the silicon oxide was about 60%, the mass percentage of the aluminum oxide was about 15%, the mass percentage of the sodium oxide was about 5%, the mass percentage of the potassium oxide was about 5%, and the mass percentage of the glass fiber was about 10%. The spraying powder further comprises ferric oxide. The mass percentage of ferric oxide is about 1%. The enamel composite layer 13 had a porosity of about 5%.

HIP treatment of the enamel composite layer 13: the argon gas had a flow rate of about 2 L/min, the inner temperature of the furnace 30 was about 700° C., the inner pressure of the furnace 30 was about 120 MPa, the HIP process lasted for about 50 min.

Grinding the enamel composite layer 13: “1000#” type diamond abrasive paper was used to grind the enamel composite layer 13. After grinding, the surface roughness (Ra) of the enamel composite layer 13 was about 0.05 μm, the thickness of the enamel composite layer 13 was about 0.25 mm.

### Example Article 2

A metal substrate 11 was provided. The metal substrate 11 was made of titanium alloy.

The metal substrate 11 was roughened by sandblasting. After sandblasting, the surface roughness (Ra) of the second surface 115 was about 0.8 μm.

Forming the enamel composite layer 13: A spraying powder used to form the enamel composite layer 13 mainly consisted of silicon oxide, aluminium oxide, sodium oxide, potassium oxide, and boron fiber, wherein the mass percentage of the silicon oxide was about 60%, the mass percentage of the aluminum oxide was about 15%, the mass percentage of the sodium oxide was about 5%, the mass percentage of the potassium oxide was about 5%, and the mass percentage of the boron fiber was about 10%. The spraying powder further comprises calcium oxide. The mass percentage of calcium oxide is about 9%. The porosity of the enamel composite layer 13 was about 4%.

HIP treatment of the enamel composite layer 13: the argon gas had a flow rate of about 4 L/min, the inner temperature of the furnace 30 was about 700° C., the inner pressure of the furnace 30 was about 140 MPa, and the HIP process lasted for about 80 min.

Polishing the enamel composite layer 13: “2000#” type corundum abrasive paper was used to polish the enamel composite layer 13. After polishing, the surface roughness (Ra) of the enamel composite layer 13 was about 0.06 μm, the thickness of the enamel composite layer 13 was about 0.2 mm.

### Comparison Example Article

An example article coated using known methods was made for comparing with performance of the coatings of the above articles made according to the present embodiments. A metal substrate 11 was provided. The metal substrate 11 was made of stainless steel.

The metal substrate 11 was roughened by sandblasting. After sandblasting, the surface roughness (Ra) of the second surface 115 was about 0.8 μm.

Forming an enamel coating: the enamel coating was formed by electrostatic adsorption. The spraying powder used to form the enamel coating mainly consisted of silicon oxide, aluminium oxide, sodium oxide, and potassium oxide, wherein the mass percentage of the silicon oxide was about 65%, the mass percentage of the aluminum oxide was about 12%, the mass percentage of the sodium oxide was about 4%, and the mass percentage of the potassium oxide was about 4%. The spraying powder further comprises ferric oxide. The mass percentage of ferric oxide is about 1%. After the electrostatic adsorption process, during which spraying powder was adsorbed on the metal substrate 11, the metal substrate 11 was baked in an oven at a temperature of about 800° C. for about 10 min to form an enamel coating on the metal substrate 11.

Grinding the enamel coating: “1000#” type diamond abrasive paper was used to grind the enamel coating 13. After grinding, the surface roughness (Ra) of the enamel coating was about 0.05 μm.

### Results of Testing of the Example Articles

Drop tests and salt spray tests were performed on the articles of example 1-2 and the comparison example.

The articles were subjected to 300 times drop test from a height of 1 meter. The tests showed no cracks occurred in the enamel composite layer 13 in the example articles 1 and 2. Peeling of the enamel coating was found in the coating of the comparison example article.

The articles 1 and 2 were subjected to salt spray testing after the drop tests. Sodium chloride (NaCl) solution having a the mass concentration of 5% at a temperature of 35° C. was used. The test showed no pitting corrosion, and no large cracks occurring in the coated articles 1 and 2. That is, the enamel composite layers 13 of examples 1 and 2 had excellent toughness, impact resistance, and corrosion resistance.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

1. An article, comprising:
a metal substrate, and
an enamel composite layer formed on the metal substrate, the enamel composite layer mainly comprising silicon oxide, aluminium oxide, sodium oxide, potassium oxide, and fiber reinforced materials.

2. The coated articles claimed in claim 1, wherein in the enamel composite layer, the mass percentage of the fiber reinforced materials is about 8-15%.

3. The coated articles claimed in claim 2, wherein the fiber reinforced materials comprise at least one fiber selected from a group consisting of carbon fiber, glass fiber and boron fiber.

4. The coated articles claimed in claim 1, wherein in the enamel composite layer, the mass percentage of the silicon oxide is about 60-70%.

5. The coated articles claimed in claim 1, wherein in the enamel composite layer, the mass percentage of the aluminum oxide is about 15-20%.

6. The coated articles claimed in claim 1, wherein in the enamel composite layer, the mass percentage of the sodium oxide is about 4-6%.

7. The coated articles claimed in claim 1, wherein in the enamel composite layer, the mass percentage of the potassium oxide is about 4-6%.

8. The coated articles claimed in claim 4, wherein the enamel composite coating may further comprise a pigment selected from a group consisting of ferric oxide, calcium oxide, magnesium oxide, and titanium oxide.

9. The coated articles claimed in claim 8, wherein the mass percentage of the pigment is about 1-9%.

10. The coated articles claimed in claim 4, wherein the thickness of the enamel composite layer 13 is about 50 μm to about 150 μm.

11. A method for manufacturing an article, comprising:
providing a metal substrate;
forming an enamel composite layer on the metal substrate by flame spraying, the enamel composite layer mainly comprising silicon oxide, aluminium oxide, sodium oxide, potassium oxide, and fiber reinforced materials;
treating the enamel composite layer by hot isostatic pressing.

12. The method as claimed in claim 11, wherein in the enamel composite layer, the mass percentage of the fiber reinforced materials is about 8-15%, the mass percentage of the silicon oxide is about 60-70%, the mass percentage of the aluminum oxide is about 15-20%, the mass percentage of the sodium oxide is about 4-6%, and the mass percentage of the potassium oxide is about 4-6%.

13. The coated articles claimed in claim 11, wherein the fiber reinforced materials comprise at least one fiber selected from a group consisting of carbon fiber, glass fiber, and boron fiber.

14. The method as claimed in claim 11, wherein during the flame spraying process, the spray temperature is about 800-1200° C.

15. The method as claimed in claim 11, wherein the hot isostatic pressing process includes the following steps:
a fastening device is provided, the metal substrate positioned on the fastening device;
a hot isostatic pressing furnace is provided, the metal substrate having the enamel composite layer configured with the fastening device positioned in the furnace, argon is fed into the furnace at a flow rate of about 2-4 L/min, the inner temperature of the furnace is about 600-800° C., the inner pressure of the furnace is about 100-200 MPa, the hot isostatic pressing process lasts for about 40-120 min.

16. The method as claimed in claim 11, wherein after the hot isostatic pressing process, the enamel composite layer is ground or polished.

17. The method as claimed in claim 11, wherein after being ground or polished, surface roughness (Ra) of the enamel composite layer is about 0.03-0.08 μm.

18. The method as claimed in claim 11, wherein before forming the enamel composite layer, the metal substrate is roughened by sandblasting or chemical etching.

19. The method as claimed in claim 18, wherein after sandblasting or chemical etching, the surface roughness (Ra) of the second surface is about 0.4 μm to about 1.2 μm.
